(19) United States
(12) Patent Application Publication
(10) Pub. No.: US 2007/0168233 A1
(43) Pub. Date: Jul. 19, 2007

(54) Method for actuarial determination of the cost of one-time procedural or professional liability insurance policy

(76) Inventor: Chris Hymel, Iowa Colony, TX (US)

Correspondence Address: DAVID G. HENRY, 418 RIVERVIEW DRIVE, WOODWAY, TX, 76712, US

(21) Appl. No.: 11/332,570

(22) Filed: Jan. 16, 2006

(51) Int. Cl. G06Q 40/00

(52) U.S. Cl. 705/4

(57) ABSTRACT

A new business method involving the algorithmic use of data from a wide variety of sources to provide the actuarial information needed to accurately assess the exposure liability and risk probabilities associated with the performance of any specific medical (or other) procedure or service. The major factors include, but are not necessarily limited to, 1) the procedure, 2) the physician or individual, 3) the patient (procedure recipient), and 4) regional or geographic considerations. In the case of medical procedures, an algorithmic actuarial determination of a per-procedure, one-time application insurance policy specific to the procedure, physician, patient, and location of region (e.g., state, county, city, etc.), as well as any additional risk factors which my be applicable.

### BACKGROUND OF THE INVENTION

1. Field of the Invention

Applicant's invention generally relates to the field of insurance. Specifically, the proposed invention is a method to determine the cost of a one-time project, service, task, event or procedure professional liability insurance policy hereinafter referred to as a “procedural policy”.

2. Background Information

Professionals are expected to have comprehensive knowledge, skill, education or training in their particular area of expertise. Virtually every professional area has their own standard of conduct by which acts or omissions are compared. By not living up to these standards, one may be held civilly liable for any damage or harm to another person or business.

Professional liability insurance, a specialty coverage that extends to both W2 employees and 1099 subcontractors, protects a business from a client's claims for errors or malfeasance. Such insurance may cover legal defense costs, even if the claim(s) are frivolous, as well as adverse judgments and court costs (up to the coverage limits on your policy).

Medical malpractice insurance covers physicians and other health care providers in the medical field for liability claims arising from their care and treatment of their patients. According to the Insurance Information Institute, the cost of medical malpractice insurance has been rising, after almost a decade of essentially flat prices. Rate increases were precipitated in part by the growing size of claims, particularly in urban areas. Among the other factors driving up prices is a reduced supply of available coverage as insurers exit the medical malpractice business because of the difficulty of making a profit and rapidly rising medical care costs. In sum, the American Medical Association claims that “[o]ur nation's medical liability system is broken.”

Jury Verdict Research, a database of more than 202,000 verdicts and settlements, reports that between 1999 and 2000, the latest year for which statistics are available, the median malpractice jury award rose 43 percent. The average award is now a whopping $3.5 million.

According to the December 2002 Issue Brief written by Emily V. Cornell (support provided by the Maternal and Child Health Bureau, Health Resources and Services Administration, U.S. Department of Health and Human Services), in some states, medical liability insurance carriers are getting out of the market, leaving either a few carriers with extremely high rates or no carriers at all. For example, many Southern Nevada doctors say soaring rate increases in medical malpractice insurance, some to $200,000 annually from $40,000, are forcing them to close their practices, retire early or double their patient load. Nevertheless, the insurance carriers that remain are quoting physician's rates double or triple those of the previous year. There is little consensus between major interest groups on the nature of the malpractice problem, its severity, its solutions, or the proper role of government, state or federal, to solve it. The loss of affordable medical malpractice insurance for providers could eventually turn into a loss of affordable, accessible healthcare, especially for high risk medical specialties such as obstetrics and neurosurgery, or in communities that are considered medically underserved.

According to a June 2003 report to congressional requesters by the U.S. General Accounting Office entitled “Medical Malpractice Insurance: Multiple Factors Have Contributed to Increased Premium Rates,” losses on medical malpractice claims make up the largest part of an insurer's costs, and this, in turn, is the primary driver of rate increases in the long run. (hftp://www.gao.gov/new.items/d03702.rDdf.)

The most basic challenge for liability insurance is keeping coverage available. New research suggests that for any turnaround to take root significant reforms in the liability system need to occur. No prior art is directed to any such significant reforms.

Today's internet infrastructure along with the extensive collection of data and use of data mining programs allow for the development of a new business method, to be named “procedural policies” herein. The proposed invention describes the algorithmic use of data from a wide variety of sources to provide the actuarial information needed to accurately assess the exposure liability and risk probabilities associated with the performance of any specific procedure, e.g., a medical operation, in a particular context.

The term “procedure” herein describes any professional task, service, event, project or procedure which involves a unique set of individuals, entities, institutions and circumstances. The term “procedure” is most often used in relation to a medical procedure; however, in the context of this invention, the term procedure could also be applied to a broader range of professions. Examples might include dental procedures, a legal case for a lawyer, a building design for an architect, or a project for an engineering professional.

No known prior art—with or without the effective and novel use of actuarial values—is remotely directed to any such significant reforms:

### Contextual Information

U.S. Pat. No. 6,937,990 issued to Walker, et al. on Aug. 30, 2005 and is entitled “System for syndication of insurance.” It is a system for facilitating a syndicated sale of an insurance policy. The system employs a processor and a storage device connected to the processor, and a data receiving device and data output device connected to the processor. The processor executes a program to receive information relating to the insurance policy, and to transmit for electronic viewing by a potential buyer an invitation to offer to buy a share in the underwriting of the insurance policy. The share has associated therewith a risk cost assessable to the buyer if payment is made on a claim under the insurance policy. The processor receives offers to underwrite the share of the insurance policy; each offer includes information identifying collateral against which the risk cost may be charged in the event of payment on a claim. The transmission of the invitation and the offer to buy a share may advantageously be made on the Internet.

The proposed invention makes an actuarial determination of the premium for the issuance of a policy to cover specifically a single procedure using a range of risk determinants. The proposed invention does not provide any mechanism for the offer of shares in the policy and, thus, distributes the risk through the automated creation of an underwriting syndicate, as in the Walker patent. While syndicated underwriting of the insurance policies may well be accomplished by using this method and utility, the only overlap between the two inventions is use of computers and internet.

U.S. Pat. No. 6,879,959 issued to Chapman, et al. on Apr. 12, 2005 and is entitled “Method of adjudicating medical claims based on scores that determine medical procedure monetary values.” It is a method of adjudicating a medical claim by providing requirements for a first claim and a second claim, receiving a medical claim for a medical procedure, setting a first score for the first claim and a second score for the second claim to an initial value, comparing components of the medical claim to the requirements of the first and second claims, changing the first and second scores for each one of the components that match one of the requirements and for each one of the requirements that is missing from the components, and selecting the first or second claim based upon predetermined criteria applied to their respective scores to determine either a monetary value of the medical procedure for a medical service provider associated with the medical procedure or a monetary value of medical coverage for a patient associated with the medical procedure.

While the Chapman patent describes a method for real-time processing of medical procedure pre-approval, medical claim submission and claim payment amount determination, it has nothing to do with the actuarial determination of a premium for a one-time procedural policy application, like the proposed invention, which takes into account the range of the unique combination of risk factors associated with the issuance of a procedural policy, as described in the present invention.

U.S. Pat. No. 6,871,990 issued to Kansal on Mar. 22, 2005 and is entitled “System and method of assessing and rating vendor risk and pricing of technology delivery insurance.” The patent describes a ratings system method for determining the cost of an insurance policy or surety bond based on the probability that the vender bidding on the project would fail to perform or default on delivery of a technology project, and thus, leveling the bidding “playing field” by adding a cost premium for higher risk bidders. In the Kansal patent, rating factors are used to determine the relative risk between vendors in order to perform a risk/benefit analysis in determine the bid selection instead of simply choosing the lowest bid.

Some characteristics of the Kansal patent may resemble aspects of the present invention, in that additional risk factors are used for a cost/benefit analysis associated with competitive bid consideration. While various risk factors are considered, these factors are not used to determine a procedural policy premium for the unique combination of circumstances. However, while the use of the applicable risk factors is analogous, the Kansal patent is not designed for either the same application nor does it take into account the broad range of risk factors described in present invention.

U.S. Pat. No. 6,862,571 issued to Martin, et al. on Mar. 1, 2005 and is entitled “Credentialer/Medical malpractice insurance collaboration.”

The Martin patent describes the use of credentialing information in the medial malpractice insurance application process. While credentialing may well be one of the factors used in the determination of the procedural policy premium, it represents only one of several diverse factors many of which are not associated with the physician or health care provider at all. The process described in the '571 patent could be used to provide input information for use in procedural policy actuarial determination but does not cover the scope of the present invention scope nor is it sufficiently comprehensive to be considered an alternative to the procedural policy business method or utility.

U.S. Pat. No. 6,272,471 issued to Segal on Aug. 7, 2001 and is entitled “Method and apparatus for deterring frivolous professional liability claims. U.S. Pat. No. 6,615,181 also issued to Segal on Sep. 2, 2003 and is entitled “Digital electrical computer system for determining a premium structure for insurance coverage including for counterclaim coverage.”

Both of Segal's patent, i.e., the '471 and '181 patents provide a method for providing and publicly advertising a malpractice counterclaim insurance policy as an offensive tactic to deter the filing of baseless or frivolous lawsuits. The counterclaim insurance method not only provides the resources to mount a counterclaim suit, but also publishes the names of the professional carrying the policy publicly for the purpose of deterring one from filing frivolous lawsuits against the professional.

The methods of the '471 and '181 patents do not provide the same function, nor perform their functions in the same manner as the proposed procedural policy invention. The '471 and '181 inventions do not provide for professional liability insurance that specifically covers a unique combination of circumstances and the related risk factors associated with these circumstances as a one-time policy for that particular situation, as opposed to a calendar-based umbrella policy as embodied in current medical malpractice insurance.

U.S. Pat. No. 6,584,446 issued to Buchanan, et al. on Jun. 24, 2003 and is entitled “System for underwriting a combined joint life and long term care insurance policy which is actuarially responsive to long term care demands and life expectancies of the individual insureds.”

This invention provides a method for determining insurance premiums for insurance in which the coverage covers the combination of specified long term care benefits with a joint and last survivor life insurance product in such a way that the specified benefits are actuarially responsive to the insureds' actual long term care requirements as well as their life expectancies.

The appropriate risk factor related to a particular set of circumstances, in this case, life expectances and long term care benefits, are also taken into account in the proposed invention. However, the application of the '446 patent is not professional liability nor is it linked to a specific procedure (e.g., healthcare), project (e.g., engineering) or case (e.g., legal).

U.S. Pat. No. 6,456,979 issued to Flagg on Sep. 24, 2002 and is entitled “Method of evaluating a permanent life insurance policy.” The '979 patent teaches a method of evaluating a permanent life insurance policy, including the steps of establishing a benchmark cost of insurance value, obtaining a policy illustration, resolving an illustrated cost of insurance value from the policy illustration, and comparing the benchmark cost of insurance value with the illustrated cost of insurance value. Gender-based risk values reflect the differing mortality rates experienced between males and females over a lifetime. Lifestyle-based risk values may acknowledge dangerous activities such as tobacco use, job occupation and the like. Pricing method risk values are based on the statistical evidence that affluent individuals generally lead healthier lifestyles while also purchasing substantial policy values.

Like other (and previous) related methods, the method of the '979 patent makes use of the particular set of risk factors related to, in this case, life expectances. However, again, the application of the '979 patent is not professional liability nor is it linked to a specific procedure (e.g., healthcare), project (e.g., engineering) or case (e.g., legal), like the proposed invention.

U.S. Pat. No. 6,088,677 issued to Spurgeon on Jul. 11, 2000 and is entitled “System for exchanging health care insurance information.” The Spurgeon patent is an information-exchange system that controls the exchange of business and clinical information between an insurer and multiple health care providers. For example, the information-exchange system provides for the preparation, submission, processing, and payment of claims over the local area network and with push technology over the Internet. In addition, prior authorization requests may be initiated in the provider computers and exchanged over the information-exchange system for review by the insurer computer.

While a system of the '677 patent could be used to provide some of the information related to the range of risk factors that are used to determine a premium for a policy, it does not describe a system and method to perform actuarial determination of the costs associated with the various related risk components for the determination of the cost of one-time procedural, project, or case insurance policy, as taught in the present invention.

U.S. Pat. No. 6,163,770 issued to Gamble, et al. on Dec. 19, 2000 and is entitled “Computer apparatus and method for generating documentation using a computed value for a claims cost affected by at least one concurrent, different insurance policy for the same insured.” The Gamble invention pertains to a method for a computer system to calculate a financial attribute of a first insurance policy affected by the presence of a concurrent second insurance policy or multiple policies, specially where insured contingencies, risks, and/or perils of the two policies are different, but where the benefits of one policy reduce a claims cost of the other policy. The resulting savings in a claims cost of the first policy can then be used to reduce premiums charged to consumers, to add additional benefits and/or coverage at no additional premium charge to consumers, and/or to increase the insurance company's profitability. While this invention does incorporate an actuary-based algorithmic determination of claims costs and policy premiums, it's application relates to the affect of multiple policies for the same insured. It does not apply to the one-time application of the range of the unique combination of risk factors associated with the procedural policy as described in the present invention.

U.S. Pat. No. 5,523,942 issued to Tyler, et al. on Jun. 4, 1996 and is entitled “Design grid for inputting insurance and investment product information in a computer system.” The Tyler patent pertains to the development of a computer-based system and common user interface for use by an insurance agent during the sales process for entering personal client information and specific product interests for a variety of products, and the subsequent processing of this insurance and investment product information. More particularly, the Tyler invention pertains to a system and method for requesting and entering either quoted or actual information on insurance and investment products, such as, annuity, life and disability insurance and investment products. This system allows for the automated calculation and determination of insurance or investment product which conform to the combined personal information and product information.

The proposed invention does algorithmically determine a specific policy premium given a range of risk determinants, in a somewhat analogous manner as described in the Tyler patent. However, the invention does not essentially match personal information with existing insurance or investment products, but rather makes an actuarial determination of the premium for the issuance of a policy to cover specifically the single procedure in question under the unique set of circumstances

U.S. Pat. No. 6,865,567 issued to Oommen, et al. on Mar. 8, 2005 and is entitled “Method of generating attribute cardinality maps.” This invention provides a novel means of minimizing response time and resource consumption when optimizing a query in a database, and other like structures. The invention has also applications in pattern recognition, message routing, and in actuarial sciences. However, the proposed invention is substantially different: The proposed invention might well benefit from the use of a database query optimizing algorithm, such as the one described in the Oommen patent when specific data inquiries are generated in order to obtain the data required to generate actuarial determination used to compute the procedural policy premium. The Oommen patent describes a method and system for optimizing database queries which may have application in actuarial determination. Unlike the proposed invention, however, it does not perform the same function, nor provide the same benefits as the proposed invention.

U.S. Pat. No. 6,009,402 issued to Whitworth on Dec. 28, 1999 and is entitled “System and method for predicting, comparing and presenting the cost of self insurance versus insurance and for creating bond financing when advantageous.” The Whitworth patent describes a system for predicting, comparing, and presenting a cost of self insurance versus a cost of insurance using a computer system and novel programs to 1) estimate a cost of self insurance by processing self insurance information; 2) estimate a cost of insurance and savings realized by replacing self insurance with insurance by processing insurance information; 3) adjust the savings where the cost of self insurance is not equal to an average cost of self insurance; and 4) a) generate and provide an indication of the cost of a liability, the cost of insurance, and the savings; b) determine a plurality of payout patterns for a premium financing mechanism employed to pay for the insurance, and c) provide an indication of the payout pattern.

Some of the methods used to determine the cost of liability for comparison to the cost of insurance may incorporate actuarial determinations. However, unlike this patent, the proposed invention describes a method and system which determines the cost associated with a procedural policy for a unique set of risk-related variables, as described above, while the Whitworth patent provides a mechanism for the comparison of options related to the liability cost self-insurance versus the cost of insurance itself.

U.S. Pat. No. 5,933,815 issued to Golden on Aug. 3, 1999 and is entitled “Computerized method and system for providing guaranteed lifetime income with liquidity.” The object of the Golden patent, using a computer system and computerized methods, is to: 1) implement and administer a program to provide guaranteed lifetime income to a person based at least on an initial contribution of assets while providing the person a measure of liquidity in the assets; 2) optimize the use of retirement assets while providing the retiree with guaranteed income for the remainder of his or a joint annuitant's life; 3) automatically allocates an initial contribution of assets, such as from an IRA or retirement plan, according to a desired payment plan among a series of guaranteed financial vehicles with a determinable market value and at least one life contingent financial vehicle.

On the other hand, the proposed invention has nothing to do with optimizing the use of retirement and other assets to provide guaranteed income. As stated previously, the goal of the proposed invention is to perform actuarial determination of the costs associated with the various related risk components, described below, for the determination of the cost of one-time procedural insurance policy as described above.

U.S. Pat. No. 5,878,405 issued to Grant, et al. on Mar. 2, 1999 and is entitled “Pension planning and liquidity management system.” The Grant patent describes a pension-based liquidity management data processing system that supports participant decision making and flexibility with respect to loans, contribution rates, and retirement spending. It describes a system which is designed to: (1) monitor pension-based liquidity while enabling maximum pension-based liquidity allowed within regulatory limits, and that operates in conjunction with a new or existing pension plan; and (2) interface with any new or existing prior art credit card system to efficiently distribute disbursements, information, and collect payments while allowing a variety of card companies to compete within a given plan.

The Grant patent is unrelated to actuarial determination of the costs associated with the various related risk components, described below, for the determination of the cost of one-time procedural insurance policy as described in this proposed invention.

U.S. Pat. No. 5,191,522 issued to Bosco, et al. on Mar. 2, 1999 and is entitled “Integrated group insurance information processing and reporting system based upon an enterprise-wide data structure.” The Bosco patent describes an integrated information storage processing and reporting system for processing and supervising a plurality of group insurance accounts constructed with a single enterprise-wide relational data base. This system provides sales, underwriting, administration and actuarial functions through integrated program-controlled data processing systems specific for each function and communicating with a group insurance account data bank. Each function is accessible through a single integrated workstation.

While a system of this type could potentially be used to perform to store and process information related to the issuance of procedural policies, this patent does not describe a system and method to perform actuarial determination of the costs associated with the various related risk components, described below, for the determination of the cost of one-time procedural insurance policy as described above.

U.S. Pat. No. 6,802,810 issued to Ciarniello, et al. on Oct. 12, 2004 and is entitled “Care Engine.” This patent describes an invention that addresses certain problems associated with healthcare management by providing a clinically sophisticated, comprehensive solution to improve the quality and manage the costs of care. The present invention includes software applications and services that are broadly organized under three product/service offerings including: (i) application tools for identifying potentially problematic patient cases before they become effective problems, (ii) case and disease management applications and programs for managing problematic and complex cases and (iii) applications and services to improve overall risk underwriting profitability.

While information derived from the use of the Ciarniello patent may provide data which could be used by the proposed invention, the Ciarniello patent does not perform actuarial determination of the costs associated with the various related risk components for the determination of the cost of a one-time procedural insurance policy, as described in the proposed invention.

U.S. Pat. No. 5,764,923 issued to Tallman, et al. on Jun. 9, 1998 and is entitled “Medical network management system and process.” The object of the Tallman invention to provide a medical network management system and process system based on understanding and managing the process of care, in an integrated manner, from the onset of patient perception of possible needs. It additionally is intended to 1) allow beneficiaries to obtain appropriate care, at the appropriate time, from an appropriate provider; 2) effectively reduces utilization and costs, while increasing user satisfaction and overall quality of care; and 3) uses unique information systems to help guide patients through and manage the process of care, thereby assuring quality health care.

Like the Ciarniello patent (U.S. Pat. No. 6,802,810, “Care Engine”), information derived from a system based on the Tallman patent may provide data that could be used by the present invention. However, it does not perform actuarial determination of the costs associated with the various related risk components for the determination of the cost of a one-time procedural insurance policy, as described in the proposed invention.

U.S. Pat. No. 5,915,241 issued to Giannini on Jun. 22, 1999 and is entitled “Method and system encoding and processing alternative healthcare provider billing.” The Giannini invention describes a method and system to standardize, encode, and process healthcare provider billing, which handles encoding, describing and processing fee charges for specific procedures of non-conventional medicine. The process and system compiles provider and patient data by geographical location, specifically by state, for any alternative practice and produces a universal set of codes to identify fees falling within a legal or regulatory scope associated with a provider's practice. This patent addresses the problem in adequately coding and facilitating payment of claims typically not included in standard procedure coding due to the non-conventional nature of the treatments.

While the Giannini system does obtain and compile provider and patient data related to patient billing by geographical location, it does not differentially analyze risk components associated with either the regional awards averages or risks associated with specific procedures as is described in the proposed invention.

U.S. Pat. No. 6,704,644 issued to Kobayashi, et al. on Mar. 9, 2004 and is entitled “Consultation business support system.” This patent describes an expert system to guide the handling of inquiries from insured clients including, but not limited to, accident reports, questions, complaints etc. The system provides preprogrammed guidance to the insurance personnel, which guides the inquiry answers and provides the pertinent inquiry-related information to facilitate administration of such client inquiries.

The Kobayashi patent is unrelated to actuarial determination of the costs associated with the various related risk components for the determination of the cost of a one-time procedural insurance policy, as described in the present invention.

U.S. Pat. No. 5,995,939 issued to Berman, et al. on Nov. 30, 1999 and is entitled “Automated networked service request and fulfillment system and method.” This invention relates to automated service request and fulfillment systems, particularly systems in which requests are made and fulfilled over a computer network. More specifically, the invention describes the use of computers by professionals, such as doctors, and “sponsor” computers at the sites of service providers such as test labs or insurance companies, which are interconnected with a mail server system that exchanges e-mail messages via the Internet or a similar network which also convert data records into a “universal” format and thus facilitates the information and service or other request communication.

While such an interconnected information infrastructure as in the Berman invention might facilitate communications and data exchange related to the use of procedural policies, the Berman patent does not involve actuarial determination of the costs associated with the various related risk components for the determination of the cost of a one-time procedural insurance policy, as describe in the proposed invention.

U.S. Pat. No. 5,301,105 issued to Cummings, Jr. on Apr. 5, 1994 and is entitled “All Care health management system.” The Cummings, Jr. invention is a fully integrated and comprehensive health care system that includes the integrated interconnection and interaction of the patient, health care provider, bank or other financial institution, insurance company, utilization reviewer and employer so as to include within a single system each of the essential participants to provide patients with complete and comprehensive pre-treatment, treatment and post-treatment health care and predetermined financial support therefore.

Like U.S. Pat. No. 5,764,923 (“Medical network management system and process”) and U.S. Pat. No. 6,802,810 (“Care Engine”), information derived from a system based on the Cummings, Jr. patent might be used to provide data which could be used by the proposed invention. However, the Cummings, Jr. invention does not perform actuarial determination of the costs associated with the various related risk components for the determination of the cost of a one-time procedural insurance policy, as described in the present procedural policy invention.

U.S. Pat. No. 5,191,522 issued to Bosco, et al. on Mar. 2, 1993 and is entitled “Integrated group insurance information processing and reporting system based upon an enterprise-wide data structure.” This patent describes an integrated information storage processing and reporting system for processing and supervising a plurality of group insurance accounts was constructed with a single enterprise-wide relational data base. The system provides sales, underwriting, administration and actuarial functions through integrated program-controlled data processing systems specific for each function and communicating with a group insurance account data bank. Each function is accessible through a single integrated workstation.

While a system of this type could be used to store and process information related to the issuance of procedural policies, this patent does not describe a system and method to perform actuarial determination of the costs associated with the various related risk components for the determination of the cost of a one-time procedural insurance policy as described in the present invention.

The above-described, contextual methods and systems may fulfill their respective, particular objectives and requirements, but needs addressed by the present invention remain. Needed is a method that represents a potentially significant reform in the professional liability insurance system, especially but not limited to the medical liability system that is also effective and equitable to all parties involved.

The present invention, in a unique manner and providing a unique result, includes a method for determining (for all involved parties) the appropriate cost of a one-time procedural insurance policy.

### SUMMARY OF THE INVENTION

It is an object of the present invention to provide a method for reforming the professional liability system, especially but not limited to the medical liability system.

It is another object of the present invention to describe the algorithmic use of data from a wide variety of sources to provide the actuarial information needed to accurately assess the exposure liability and risk probabilities associated with the performance of any specific procedure, task, event, project or service.

It is another object of the present invention to utilize existing collections of data and data mining programs in practicing a new business method, the results of which practice facilitates the more informed pricing of insurance policies in a manner which, more than ever before possible, avoids unduly favoring, or penalizing either the insurer(s), or the insured(s) through lack of use of such information.

In satisfaction of these and related objectives, Applicant's present “Procedural Policy” invention provides a system and method for integrating a range of pertinent risk factors associated with a specific service, task, project, event or procedure including, but not limited to
1) The Procedure—the risks associated with providing the particular service, task, project, event or procedure itself (in the case of a medical procedure, the known risk and complication factors),
2) The Service Provider—the history, skills, experience and competency of the professional(s), services provider(s) or physician(s) involved in the service, task, project, event or procedure (in the case of a medical procedure, certification, experience success/failure history),
3) The Service Recipient—Risks associated with the service recipient fall into two broad categories:
   a) service recipient's current status, complicating or procedure-related historical factors (e.g for a medical procedure; medical status, history and family history),
   b) the service receiver's litigation propensity as relates to financial, litigation, credit or criminal history, and
5) Location—location specific risk fall into three categories:
   a) jury award statistics for the particular local or region, and related to the specific event or procedure at-issue.
   b) regulatory or legislative considerations, such as tort reform legislation, which may limit awards for certain damages,
   c) In the case of medical procedure, the hospital in which the procedure is being performed, utilizing such input as mortality and morbidity rates

Real-time access to these risk factors allow for the actuarial determination of a professional liability policy cost for the unique combination of risk factors associated with a specific task, project, service, event or procedure. Thus, the present invention provides a first line of risk management insurance that also reduces the costs associated with carrying medical malpractice “umbrella” insurance for those procedures which are consider “schedulable”.

The present method for the first time makes possible the appropriate pricing of event-specific insurance policies (“procedural policies”) which, in turn: (1) avoids the de facto, per-event higher insurance premiums (or even insurance unavailability) unavoidably arising from presently employed premium setting methods; (2) makes insurance coverage available (albeit at a per-procedure higher premium) for individual events or procedures which, if the insurance for same were aggregated with that for other, lower-risk procedures, may make undertaking the event or procedure an uninsurable event, or cost prohibitive for a service provider; and (3) facilitates the providing of lower insurance premiums (relative to present rate structures) for specific events the circumstances of which, after use of the proposed systems and methods, are shown to justify such a lower premium.

### DETAILED DESCRIPTION OF THE PREFERRED EMBODIMENT

The present invention will be described with reference to medical procedures specifically, but may be extended to use in non-medical contexts.

There are different kinds of risks reflected in medical statistics, or epidemiology. An absolute risk is the actual probability of some event or procedure affecting someone in a particular population. For example, one can assert that the actual risk of a recipient contracting HIV or other viral infections can be calculated as the product of the prevalence of the disease in the donor population and the chance that the donor is in the window period at the time of the donation. (Risk=(prevalence×window period in days)/365).

Absolute risk is different from relative risk. A relative risk is a comparison between two (or more) risks. In general, it is more accurate to look at absolute risks when deciding on an event, procedure or a treatment, because it is more revealing of the true or actual probability of something happening.

The proposed invention involves the algorithmic use of data from a wide variety of sources to provide the actuarial information needed to accurately assess the exposure liability and risk probabilities associated with the performance of any specific medical (or other) procedure to be performed. The major factors include, but are not necessarily limited to, the following components:

1) The procedure: Most procedures have an inherent risk associated with their performance. Examples include factors such as the risk of infection, failure rates, adverse reactions, etc., as well as the history of the procedure itself. The majority of these procedures have a long history and these statistical risks are well understood, whereas relatively new procedures will have a less defined success/failure record and long-term effects history.

2) The physician or individual: Examples include: the individual's performance history, the individual's general experience level, the numbers of times the individual has performed the specific procedure, the physician's overall and specific success rate, as well as the individual's litigation history.

3) The patient (procedure recipient): Risk associated with the patient includes such issues as the patient's overall health and, as such, the patient's unique complicating factors. In addition, patient factors include but not limited to the probability that, given an adverse result, the patient will seek to monetary damages. This risk may depend on a number of factors, including the patient's current economic situation, credit/criminal/litigation history, etc.

4) Location or Regional considerations: Significant variation occurs between different locales related to the average size of jury awards, the litigation history, etc., as evidenced in the different risk rating associated with various counties for region specific reasons exemplified by differences in various types of insurance rate for different counties. For example, coastal regions tend to have higher HO policy rates, densely populated areas have higher auto insurance rates, etc. Malpractice insurance rate increases vary significantly from state to state, in large part reflecting the strength (or weakness) of each state's protections against eye-popping settlements exemplified by recent state legislation related to tort reform which serve to regulate awards for certain types of damages. In addition to regional or state related considerations, the choice of hospital impact the outcome risk, given the variation in morbidity and mortality rates vary between hospitals for different types of procedures.

In the case of medical procedures, the proposed invention is an algorithmic actuarial determination of a per-procedure, one-time application insurance policy specific to the procedure, physician(s), patient, and location of region (by state, county, city, etc.), as well as any additional risk factors which my be applicable.

In a typical medical application or embodiment, the following broad risk factor categories are representative of the risk categories used to determine the cost of the procedural policy. These factors include 1) patient risk factors, 2) physician risk factors, 3) procedure specific factors, and 4) location specific risk factors.

1) Patient Risk Factors: Collectively, patient specific history is used to determine “patient risk factors.” The patient-specific factors may include two broad subcategories: i) medical-related history, and ii) other history factors. The medical history information is used to determine relevant medical issues, which may be considered relevant to the risk associated with the procedural outcome for a medical perspective. A thorough medical history is critical to assessing the applicability and risk of a specific procedure given the patient-specific set of medical factors, e.g., history of heart disease, diabetes, high blood pressure, etc. These factors relate directly to the expected outcome of the procedure. These factors are also considered under the “procedure risk factors,” described below.

Additional patient risk factors are obtained through the use of a patient's personal information, such as social security number and/or driver license's number and a properly executed information release form to provide access to such information. This information is entered into a computer in the physician's office or at a hospital and is used by a risk assessment system to critically review and assess various databases for such relevant information, e.g., litigation history, credit history, driving record, criminal history, etc. Basically, the patient information used would include any information that may be influential or have an effect on the assessment of the risk of litigation by the patient. Collectively, patient specific history is used to determine “patient risk factors”.

2) Physician(s) Risk Factors: In this embodiment, these factors would typically be on file and automatically updated. The physician(s) related information includes such factors as the doctor's litigation and subsequent outcome record, general experience level, experience specific to the procedure to be performed, certification, etc. In many cases, information for multiple physicians would be accounted for (e.g., a surgeon and anesthesiologist).

3) Procedure Risk Factors: Any medical procedure, especially invasive procedures, has inherent risks associated with its performance. For example, for genetic amniocentesis, the overall procedure-related pregnancy loss may be 1/200. The risk of infection is approximately 1/1000. These factors, as well as all other risk factors associated with any procedure, must be taken into account in any actuarial determination of risk. Additional confounding factors exist related to the patient's medical history (discussed above under the “patient risk factors” section), which may increase certain procedural risk factors.

There are also procedures in which the ability and time required to assess damage and, therefore, liability on the part of the physician may vary significantly. For example, damage to a newborn caused during delivery may take considerably longer to assess (>10 years) than the damage due to infection when removing an appendix. This presents an additional element to the actuarial determination of the procedural risk factor.

4) Location or Region Specific Risk Factors: Different regions of the country have different probabilities associated with not only the likelihood of assigning liability to a physician but also with the assessment of the size of the award for damages. In Texas, for example, in the Corpus Christi area, juries are more likely to find in favor of and assess greater damage awards to an injured patient, than would a jury in Houston.

In addition, many states have enacted tort reform legislation which limits jury awards associated with professional liability and thus, reducing economic risks. For example, tort reform in Texas caps jury awards for “non-economic” damages to $250,000.

Further, significant variability in mortality and morbidity rates associated with different hospitals for the same medical procedures. As such, location specific risk factors could include the choice of hospital.

In addition, some complicating health factors are region specific. An example is the documented increased incidence of asthma in the Houston area. These regional related health factors could also be included in a comprehensive risk factor analysis.

As such, actuarial determination of state, regional locale or hospital specific risk factors should be considered and included in determination of the cost of any procedural policy.

The above four major risk factor categories are not, nor are they meant to be, exclusive or exhaustive. There may additional risk factors that could be included given the particular situation.

Once the appropriate risk factors have been determined and actuarial probabilities have been assigned, the projected financial exposure for performing any single procedure can be determined. The cost of coverage for the single procedure, with the particular patient, particular physician(s), at a particular location , etc., can be determined prior to the performance of said procedure and a liability policy covering that procedure under the unique circumstances can than be purchased and issued.

This method of the present invention is applicable to a wide range of professional liability, including, for example, various medical procedures including, but not limited to, elective and scheduled procedures. It can also be implemented as a first line of liability coverage that potentially reduces the umbrella coverage requirements associated with medical malpractice insurance. As such, this model can also be applied to a wide range of additional liability areas, e.g., legal malpractice, construction, engineering, etc.

In its simplest form, practice of the present invention will involve, in any given context, the user determining the factors to be considered (or not to be considered) for insuring any particular type of event or procedure as well as the weight to be given to each such factor. For example, risks associated with pregnancy, or likely pregnancy, will not come into consideration for prostate treatment procedures. Also, the weight given practitioner experience may be somewhat less when formulating premium factors for a particular procedure which is considered relatively “simple”, while jury award trends for a particular area may be given greater weight when considering a procedure which is known for high litigation risks (obstetrics, for example). The result of this analysis will, in more simple implementations, be some multiplier which will likely be applied to a premium baseline reference to arrive at an event-specific premium. Far more complex analysis may also be involved. However, in any event, the present invention lies in applying actuarial and contextual factors in the risk assessment and premium setting for event-specific insurance policies (“procedural policies”).

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention.

It is, therefore, contemplated that the appended claims will cover such modifications that fall within the scope of the invention.

I claim:

1. A method for providing insurance services comprising the steps of:
assigning a first numerical factor related to risks associated with a particular service, proposed by a service provider, to be provided to a prospective services consumer;
assigning a second numerical factor to information reflecting a prospective services consumer's personal history;
calculating, using computing means, an insurance premium for an insurance policy providing coverage expressly related to said particular service, said calculating including the use of said first numerical factor and said second numerical factor.

2. The method of claim 1 further comprising the step of issuing said insurance policy to said service provider.

3. The method of claim 1 wherein said particular service is a medical, surgical or dental procedure.

4. The method of claim 2 wherein said particular service is a medical, surgical or dental procedure.

5. The method of claim 1 further comprising the steps of assigning a third numerical factor to information reflecting jury award statistics and calculating said insurance premium through use of said third numerical factor.

6. The method of claim 2 further comprising the steps of assigning a third numerical factor to information reflecting jury award statistics and calculating said insurance premium through use of said third numerical factor.

7. The method of claim 3 further comprising the steps of assigning a third numerical factor to information reflecting jury award statistics and calculating said insurance premium through use of said third numerical factor.

8. The method of claim 1 further comprising the steps of assigning a fourth numerical factor to information reflecting said service provider's qualifications for providing said particular service.

9. The method of claim 2 further comprising the steps of assigning a fourth numerical factor to information reflecting said service provider's qualifications for providing said particular service.

10. The method of claim 3 further comprising the steps of assigning a fourth numerical factor to information reflecting said service provider's qualifications for providing said particular service.

11. The method of claim 4 further comprising the steps of assigning a fourth numerical factor to information reflecting said service provider's qualifications for providing said particular service.

12. The method of claim 5 further comprising the steps of assigning a fourth numerical factor to information reflecting said service provider's qualifications for providing said particular service.

13. The method of claim 6 further comprising the steps of assigning a fourth numerical factor to information reflecting said service provider's qualifications for providing said particular service.

14. The method of claim 7 further comprising the steps of assigning a fourth numerical factor to information reflecting said service provider's qualifications for providing said particular service.

15. A method for providing insurance services comprising the steps of:
assigning a first numerical factor related to risks associated with a particular service, proposed by a service provider, to be provided to a prospective services consumer;
assigning a third numerical factor to information reflecting jury award statistics and calculating said insurance premium through use of said third numerical factor; and
calculating, using computing means, an insurance premium for an insurance policy providing coverage expressly insuring said services provider related to said particular service, said calculating including the use of said first numerical factor and said third numerical factor.

16. The method of claim 15 further comprising the step of issuing said insurance policy to said service provider.

17. The method of claim 15 wherein said particular service is a medical, surgical or dental procedure.

18. The method of claim 16 wherein said particular service is a medical, surgical or dental procedure.

19. A method for providing insurance services comprising the steps of:
assigning a first numerical factor related to risks associated with a particular service, proposed by a service provider, to be provided to a prospective services consumer;
assigning a fourth numerical factor to information reflecting said service provider's qualifications for performing said particular service, and calculating said insurance premium through use of said fourth numerical factor; and
calculating, using computing means, an insurance premium for an insurance policy providing coverage expressly insuring said services provider related to said particular service, said calculating including the use of said first numerical factor and said fourth numerical factor.

20. The method of claim 19 further comprising the step of issuing said insurance policy to said service provider.

21. The method of claim 19 wherein said particular service is a medical, surgical or dental procedure.

22. The method of claim 20 wherein said particular service is a medical, surgical or dental procedure.
